(19) United States
(12) Patent Application Publication
(10) Pub. No.: US 2015/0176443 A1
(43) Pub. Date: Jun. 25, 2015

(54) CHAIN-BASED TRANSFER DEVICE

(71) Applicant: IWIS MOTORSYSTEME GMBH & CO. KG, München (DE)

(72) Inventors: Michael Frank, Otterfing (DE); Reinhard Muller, Landsberg (DE); Alexander Salzseiler, Munchen (DE)

(21) Appl. No.: 14/413,691

(22) PCT Filed: Jun. 28, 2013
(86) PCT No.: PCT/EP2013/001909

§ 371 Date: Jan. 8, 2015

(30) Foreign Application Priority Data
Jul. 10, 2012 (DE) 10 2012 013 660.9

(51) Int. Cl. F01L 1/352; F16H 49/00; F16H 35/00

(52) U.S. Cl. CPC F01L 1/352; F16H 35/008; F16H 49/001; F01L 2001/3521; F16H 2049/003

(57) ABSTRACT

A transfer device is provided with variable rotation angle having an internally toothed ring gear, an externally toothed sun gear, a transmitter element and an adjustable actuation device, wherein the transmitter element comprises a circumferential engagement device arranged between the ring gear and sun gear. The actuation device comprises an activation element that can be moved along the engagement device for rotation angle adjustment. In this case, the circumferential engagement device is partially engaged with the internal toothing of the ring gear and partially engaged with the external toothing of the sun gear by means of the activation element. Moreover, a correspondingly designed camphaser of a combustion engine, and a method for adjusting the relative rotation angle position of the camshaft to the crankshaft in a combustion engine, are provided.

The present invention relates to a transfer device with variable rotation angle, in particular a camphaser for a combustion engine that is equipped with an internally toothed ring gear, an externally toothed sun gear, a transmitter element, and a variable actuator device. Furthermore, the present invention relates to a corresponding camphaser for a combustion engine, as well as a method for varying the relative rotation angle position of a combustion engine camshaft.

Power transfer devices with variable rotation angle are mainly used for operation-dependent modifications of the valve timing control in combustion engines. Depending on the respective load behavior, adjustments to the valve opening periods during operation result in efficiency increase of the combustion engine. For instance, a combustion engine with short overlapping periods of the exhaust valves and the intake valves has comparatively high torque at low RPMs, but reduced maximum power, whereas a long overlap period results in increased maximum power at reduced torque at low RPMs. In addition to fuel savings and an increase in power and torque, the increased efficiency achieved by the overlap periods of the exhaust and intake valves also results in reduced emissions and permits the attainment of ambitious exhaust standards.

Because of this power increasing and fuel-saving effect of the camphaser, modern combustion engines are frequently equipped with corresponding transfer devices with variable rotation angle. These systems employ a variety of different designs and concepts, which may be used as camphasers. Today, the most widely used approach is the hydraulic camphaser, which is based on a pivoting motor known from hydraulic engineering, and which is equipped with several vanes to enhance the transferable torque, and restricts the pivoting angle of the motor to approximately 35°. When used as camphasers in combustion engines, such hydraulic pivoting motors are driven by the engine oil loop and, due to the highly dynamic changes in the moments of the cams on the camshaft, can only be employed in combination with a check valve. For this application, the pivot motor is positioned at the camshaft end in the drive train from the crankshaft to the camshaft. Automobile manufacturers use a variety of technical solutions for the camphaser, wherein these camphasers are principally classified into systems that rotate the intake camshaft relative to the exhaust camshaft, and fully variable systems.

The function of hydraulic camphasers that are connected to the engine oil loop depends on the pressure and temperature of the engine oil in the loop. At low temperature, and therefore with highly viscous oil, a rotation angle adjustment is not possible, or only possible within certain limits, since the viscous engine oil cannot flow, or can only flow very slowly through the oil line to the camphaser. While the oil pressure is very high, the volume stream is very low. At high temperatures, the oil has very low viscosity, allowing an increase of oil loop leakages inherent to hydraulic systems. For these reasons, only low oil pressure can be maintained in the oil loop, permitting only slow adjustments to the camphaser and only a poorly maintained angle position. Moreover, the oil pressure and resulting function of the camphaser depend on the RPMs of the combustion engine.

In addition, electrically powered camphasers are known that operate independently of the oil pressure. The electrical operation of the camphaser allows the valve timing to be adjusted without the combustion engine in operation, and the frequently required supplemental hydraulic pumps needed for oil loop based operation can be omitted. Thus those electrically powered camphases improve the functional range and functional reliability of the camphaser. DE 41 10 195 A1 describes a device for electrically adjusting the relative rotation angle position of two components connected by a rotating drive. This system consists of an electrical motor with a stator permanently mounted to the housing and a rotor that rotates in unison with the actuator gear, thus permitting a rotation angle adjustment of the drive components. The actuator gear is either a threaded section with spline toothing or a circumferential gear drive with a self-locking gear ratio. The camphaser described in DE 102 48 355 A1 is operated by means of an electrically powered actuator motor as well, wherein the actuator motor operates a double eccentric gear or a double planetary gear. The attainable reduction gearing of up to 1:250 and the low friction of the gears permit self-locking of the camphaser, as well as the use of permanent magnet rotors for the actuator motor.

Camphasers or coupling devices with variable rotation angles known in the state of the art exhibit a variety of problems as a function of their design. Whereas the hydraulic pivoting motors have a problematic dependency on the pressure and temperature of the motor oil in the oil loop of the combustion engine, corresponding actuators with an electric drive exhibit disadvantages with respect to the actuation speed, the required actuation energy, as well as problematic self-locking properties with simple thread designs, or significant vibrations with eccentric gears and planetary gears with highly reduced gear ratio.

Although the known constructive designs and concepts for camshaft adjustments have demonstrated good performance in their use in modern combustion engines, on-going efforts are made especially with respect to the use of transfer devices with variable rotation angle in combustion engines, which are manufactured in large numbers for the automobile industry, in order to make improvements, to address known problems, and to explore new solutions. Moreover, in view of the high number of units needed in the automobile industry and continuing innovative efforts to increase efficiency of combustion engines, a present need exists to replace common designs with optimized or more cost effective concepts.

The intended objective aim of the invention is therefore to provide a transfer device with a variable rotation angle that is able to overcome the problems known to the state of the art with conventional actuation devices for the relative movement of two drive components, and that enables highly accurate actuation and operational reliability, while having a small build volume and low energy consumption.

This task is solved according to the present invention by a generic transfer device with adjustable rotation angle in that the transmitter element is designed as a circumferential engagement device arranged between the ring gear and the sun gear, and in that the actuation mechanism comprises an activation element movable relative along the circumferential engagement device, wherein the circumferential engagement device is partially engaged with the interior toothing of the ring gear and partially engaged with the exterior toothing of the sun gear by means of the activation element. In contrast to conventional epicyclic or planetary gears, this entirely new concept of a transfer device is arranged with an enclosed transmitter element, preferably a chain or a belt, positioned between the internally toothed ring gear and the sun gear, which has an only slightly smaller diameter and number of teeth, wherein the enclosed transmitter element wraps around the sun gear and is partially engaged with the exterior toothing of the sun gear and is partially engaged with the interior toothing of the ring gear by means of the activation element. Without a relative movement of the activation element with regard to the ring gear or the sun gear, the relative position of the ring gear to the sun gear remains the same, and any movement of the ring gear is directly transferred to the sun gear without gearing. However, when the activation elements is moved along the transmitter element, the position of the sun gear to the ring gear changes, resulting in a relative angle adjustment of the components connected to the associated drive train. In this case, in addition to the relative movement of the activation element, a drive movement can be concurrently transferred via the ring gear and the sun gear.

Even though the transfer device according to the present invention using simple components, such as a chain or belt, chain sprockets and gears from the field of drive chains or drive belts, this device permits high reduction gearing at very low friction. The high reduction gearing enables precise adjustments of the rotation angle between the components assigned to a drive train, wherein small high speed actuator motors may be used. The low friction during operation has a positive impact on the energy consumption, as well as on the heat generated in the drive. Another benefit of the transfer device according to the invention is the inherent self-locking feature of the system by means of the direct coupling of the internally toothed ring gear with the externally toothed sun gear by the transmitter element without adjusting the position of the activation element relative to the transmitter element. The self-locking feature of the transmitter element enables precise rotation angle adjustments and prevents an unintended, self-actuated mis-adjustment of the rotation angle during operation of the transfer device without additional design measures or continuous operation of the activation element. Any flexible circumferential interlocking device, for instance a chain, that ensures the partially friction or shape locked engagement of the interior toothing of the ring gear and the exterior toothing of the sprocket, and that can be engaged and disengaged from the ring gear and the sun gear by means of the movable activation element can be used as a transmitter element.

A suitable embodiment proposes that the activation element is designed as a circumferential chain scraper with at least one chain guide rail arranged between the internally toothed ring gear and the externally toothed sun gear. Upon relative movement of the activation element along the chain, the chain guide rail of the circumferential chain scraper located between the sun gear and chain disengages the chain from the exterior toothing of the sun gear and pushes the chain onto the interior toothing of the ring gear. In doing so, the chain guide rail not only presses the chain into a shape locked engagement with the interior toothing of the ring gear, but also concurrently tensions the chain across the sun gear and engages it with its exterior toothing. Such a simple design configuration of the activation element, designed as circumferential chain scraper with a chain guide rail, provides a favorable solution for separating and guiding the chain between the ring gear and the sun gear, wherein the chain guide rail tensions the chain across the exterior toothing of the sun gear and effects a secure engagement with the interior toothing of the ring gear and the exterior toothing of the sun gear.

To ensure the vibration-free operation of the transfer device, the circumferential chain scraper can be coaxially aligned with the internally toothed ring gear and the externally toothed sun gear. In this embodiment, in particular when used as a camphaser, the circumferential chain scraper rotates in unison with the internally toothed ring gear and the externally toothed sun gear around the drive or camshaft axis. To avoid imbalances, the circumferential chain scraper may be equipped with two opposing chain guide rails, thus ensuring a uniform distribution of the forces when the chain or the transmitter element is disengaged or pressed into position. The two opposing chain guide rails can preferably be arranged at the ends of the protuberances of oval hub sections, which extend in parallel to the sun gear. Moreover, three or four chain guide rails can also be employed, wherein three chain guide rails are positioned at a distance of 120° to each other on the circumferential chain scraper. In this case, in order to facilitate the concurrent stripping off and pushing the chain or the transmitter elements onto the exterior toothing of the sun gear and the interior toothing of the ring gear, the chain guide rails can be configured with a radius that tapers toward the tips of the chain guide rails.

An advantageous embodiment proposes that the transmitter elements of the transfer device are designed as double-sided silent link chain, wherein the individual chain links of the link chain is equipped with a chain pin and joint sleeve that encloses the chain pin. By using conventional components or fully assembled chains from the field of conventional high-performance silent link chains, the related synergy effects result in savings for provisioning and assembly of the coupling device. In addition to the joint sleeves, which fix the interior chain plate distances to each other, and the chain pins, which protrude through the joint sleeves, wherein the chain pins connect the exterior chain plates of the exterior chain links with the interior chain links, a joint roll may be arranged in a rotating manner around the chain sleeves. In this case, analogous to the use of chains in the field of high-performance silent link chains, the use of joint rolls that are arranged in a rotating manner around joint sleeves, reduces the wear of the chain link and the tooth with which it is engaged. As the chain securely engages into the internally toothed ring gear and the externally toothed sun gear, the link chain is configured to match the interior toothing of the ring gear and the exterior toothing of the sun gear, wherein the chain engages into the interior toothing of the ring gear on one side of the double sided link chain and the chain engages into the exterior toothing of the sun gear on the opposing, second side of the link chain.

In order to ensure a reliable power transfer and a concurrently coupling with variable rotating angle between the internally toothed ring gear and the externally toothed sun gear, the number of tooth of the interior toothing of the ring gear can be larger than the number of chain links of the chain, and the number of chain links of the chain can be greater than the number of tooth of the exterior toothing of the sun gear. The differing tooth count results in differing toothing diameters with a special tooth shape adapted to the chain, wherein the required relative movement of the ring gear and sun gear for the rotation angle adjustment necessitates that the tips of the interior toothing of the ring gear and the tips of the exterior toothing of the sun gear must be free of any overlap. While the teeth of the interior toothing of the ring gear and the exterior toothing of the sun gear respectively engage into the interior space between two adjacent chain links, so that the interior space between the chain links forms the actual reference point for the reduction gearing ratio between the ring gear and the chain and between the chain and the sun gear. However, as the chain is configured as a closed unit and is wrapped around the sun gear, the number of chain joints is used as a simplification to calculate the reduction gearing ratio, which in this device is equal to the number of interior spaces between the chain joints. In order to attain a sufficiently large reduction gearing ratio, the difference between the tooth count of the interior tooth of the ring gear to the tooth count of the exterior toothing of the sun gear is six, preferably four. The reduction gearing of the device is derived from the RPMs of the activation element to the RPMs of the sun gear and is calculated from the tooth count of the sun gear to the difference of the tooth count of the ring gear and sun gear This then results in single stage reduction gear ratios of approximately 8:1 to 20:1.

An advantageous embodiment of the transfer device proposes that the actuation device is equipped with an electrical motor to move the activation element. In contrast to conventional hydraulic drives and mechanical drives, the electrical motor is a cost effective, simple solution to move the tensioning element along the chain relative to the ring gear and sun gear. In addition to a normally small build size, electrical motors have the advantage that these can be easily adapted to various conditions.

One version of this drive proposes that the electrical motor is configured with a housing mounted stator and a rotor, wherein the rotor is attached to the activation element. Electrical motors of this kind, in particular brushless direct current motors, have the advantage of low friction and low wear, which overcompensates the additional effort needed for the electrical commutation. In this case, a housing mounted stator provides a simple, reliable and wear-resistant power supply to the stator and the windings. While a permanent magnet rotor used for this requires rear earth metals, it has high output and self-locking torque in combination with high reduction gearing of the transfer device according to the invention, and such a motor can quickly perform the rotation angle adjustment between the ring gear and sun gear and arrest this in the desired position.

Yet another embodiment proposes that the electrical motor be configured with a concurrently rotating stator and an over-rotating rotor that is attached to the activation element. An electrical motor of this kind, where the stator and the rotor uniformly rotate in unison at idle during the transfer of movement of the transfer device, and for which the rotor will only exhibit an RPM difference for the relative angle adjustment of the sun gear enables fast and accurate adjustments of the rotation angle. A disadvantage for such an embodiment of the electrical motor is the required connection of the motor to an electrical power source via slip rings and brushes, or via an inductive, contactless energy transfer.

In order to achieve larger reduction gearing with the transfer device according to the invention, the transfer device can be configured as two-stage or multi-stage embodiment, wherein, for example, the externally toothed sun gear of the first stage is connected with the second activation element of the second stage, and the second stage comprises a second externally toothed sun gear, a second internally toothed ring gear and second circumferential engagement device, which is partially engaged with the interior toothing of the second ring gear and partially engaged with the exterior toothing of the second sun gear of the second stage by means of the second activation element. All additional stages are based on a similar coupling principle, wherein, for example, the activator of the new stage is respectively connected to the output sun gear of the previous stage, and engages into a transmitter element necessary for, and solely assigned to the stage, wherein said transmitter element engages into an internally toothed ring gear common to all stages and into the externally toothed sun gear of the respective stage. In addition to the increased reduction gearing, the second stage also attains improved self-locking, without significantly increasing the dimensions of the transfer device.

The present invention also relates to a camphaser for a combustion engine having a transfer device with a variable rotation angle according to the invention, wherein the internally toothed ring gear is coupled to a camshaft sprocket that is coupled to the crankshaft, and wherein the externally toothed sun gear is coupled with a camshaft. Correspondingly, the internally toothed ring gear is connected to the crankshaft via the camshaft sprocket that is affixed to the crankshaft without any degrees of freedom in a directly forced coupling. In this case, the drive train between the crankshaft of the combustion engine can be configured as a chain drive with chain sprockets and a timing chain, or as a belt drive with timing belts and belt pulleys, or just as a toothed gear coupling. Thus, an entirely new concept for adjusting the rotation angle is provided, which uses simple components. A camphaser of this type enables good reduction gearing and an inherent self-locking mechanism for the rotation angle position between the crankshaft and the camshaft.

A further camphaser for a combustion engine in accordance with the present invention is designed as subtracting gear device. The transfer device with a variable rotation angle of this camphaser is configured with two stages. The second stage comprises a second externally toothed sun gear, a second internally toothed ring gear, a second circumferential engagement device and a second activation element. The internally toothed ring gear of the first stage is permanently connected to the second internally toothed ring gear and the activation element of the first stage is permanently connected to the second activation element. The externally toothed sun gear of the first stage is coupled to a camshaft sprocket, which is coupled with the crankshaft, and the second externally toothed sun gear is coupled to a camshaft. Such a subtracting gear device provides a special design for an ecliptic gear with high gear ratio and high RPM output, and may be used for several applications. An advantage application is the use of such a camphaser to retrofit present timing drives.

Additionally, the invention also refers to a method for adjusting the relative rotation angle position of the combustion engine camshaft to the camshaft sprocket which is fittedly coupled to the crankshaft of the motor by means of a transfer device with variable rotation angle comprising an internally toothed ring gear, an externally toothed sun gear, a chain arranged between the ring gear and the sun gear, and an activation element, comprising the steps of moving the activation element along the chain relative to the internally toothed ring gear and externally toothed sun gear; stripping the chain of the exterior toothing of the sun gear and pushing the chain onto the interior toothing of the ring gear, and adjusting the rotation angle of the camshaft coupled with the externally toothed sun gear relative to the camshaft sprocket coupled to the internally toothed ring gear. In addition to good reduction gearing and internal self-locking, the movement of the activation element along the chain between the ring gear and the sun gear for rotation angle adjustment also provides good vibration reduction, since the tensioning element, and correspondingly also the chain and the sun gear, only move relative to one another when the rotation angle position is changed. During strict transfer operation of the movement of the crankshaft coupled camshaft sprocket to the camshaft, the components of the transfer device are stationary to each other, but exhibit absolute movement with the same rotational velocity as the camshaft sprocket and the camshaft around the camshaft axis. In addition to the self-locking function achieved by the high reduction gearing of the transfer device, the tensioning element, with its chain guide rail arranged between the sun gear and the chain, achieves an additional, inherent self-locking function, because, when in fixed rotation angle operating mode, the movement of the camshaft sprocket is transferred by the ring gear and the chain directly onto the sun gear and the camshaft with which it is connected.

The following is a detailed explanation of an embodiment of the transfer device with variable rotation angle according to the invention on the basis of the attached drawings. The drawings show:

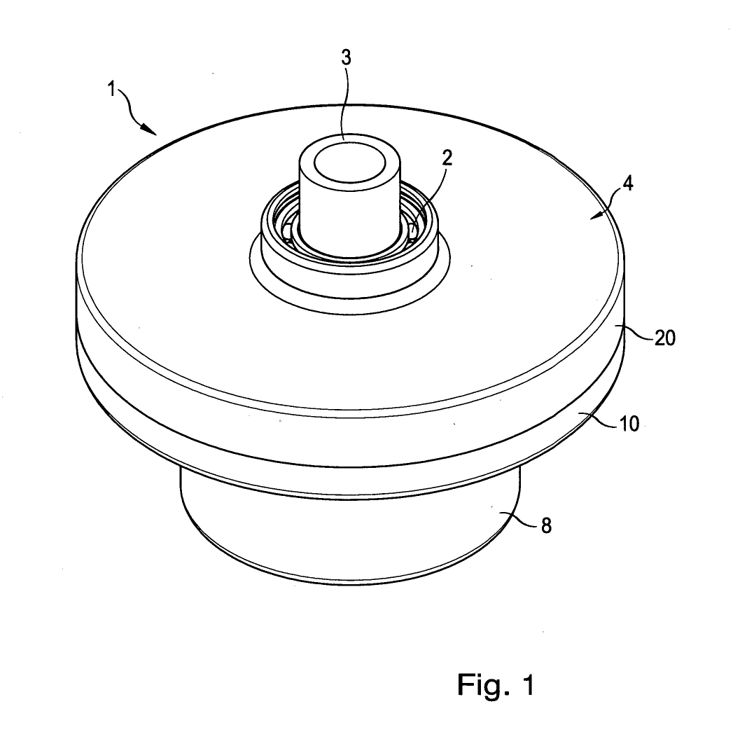

FIG. 1 a perspective drawing of a transfer device with a variable rotation angle according to the present invention, in particular for a camphaser;

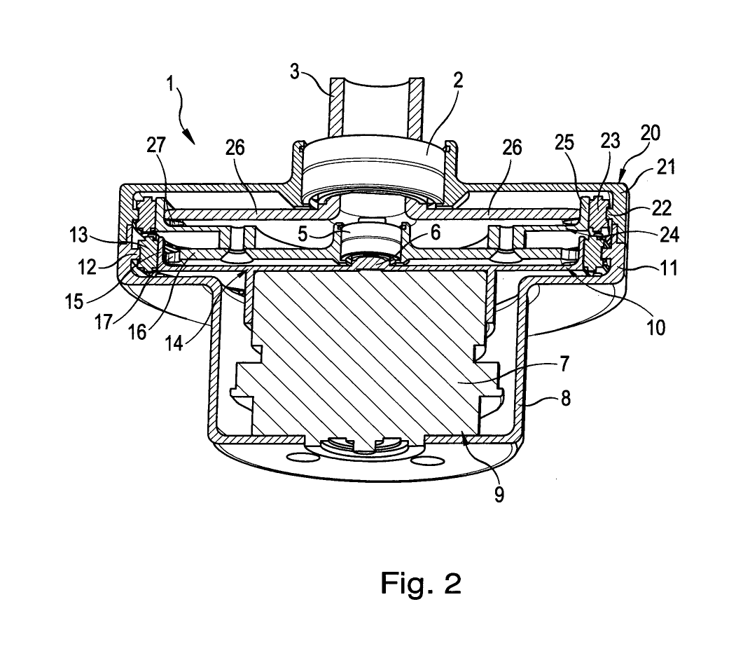

FIG. 2 a cross section through the transfer device from FIG. 1;

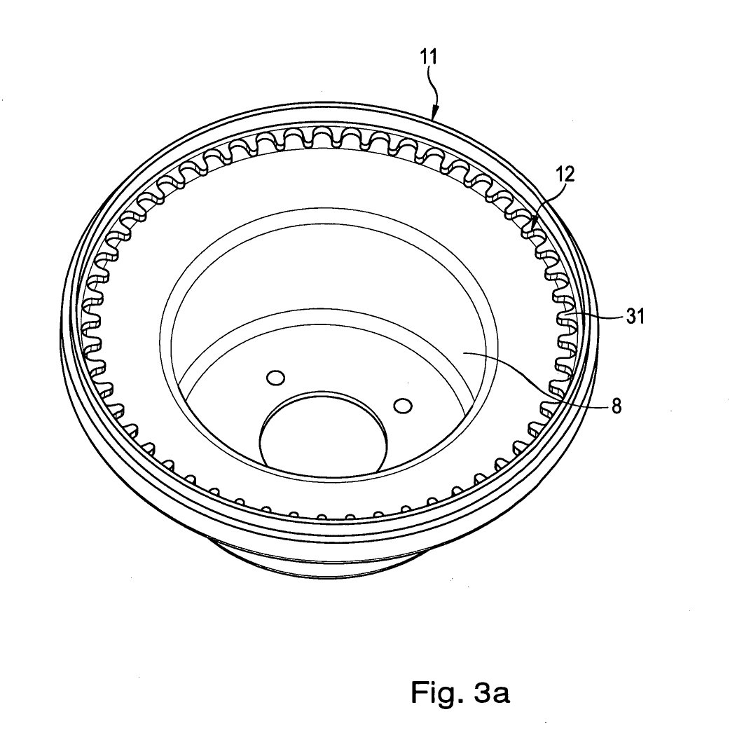

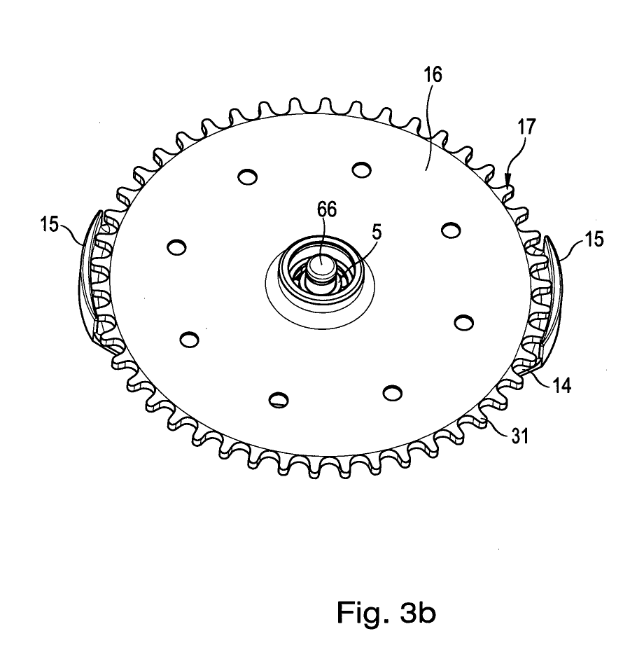

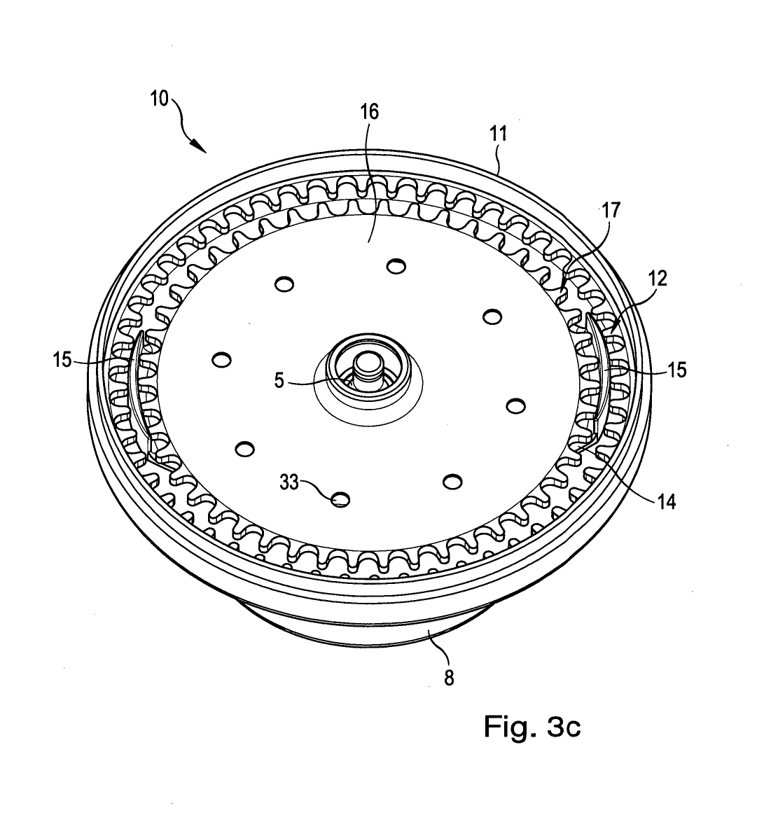

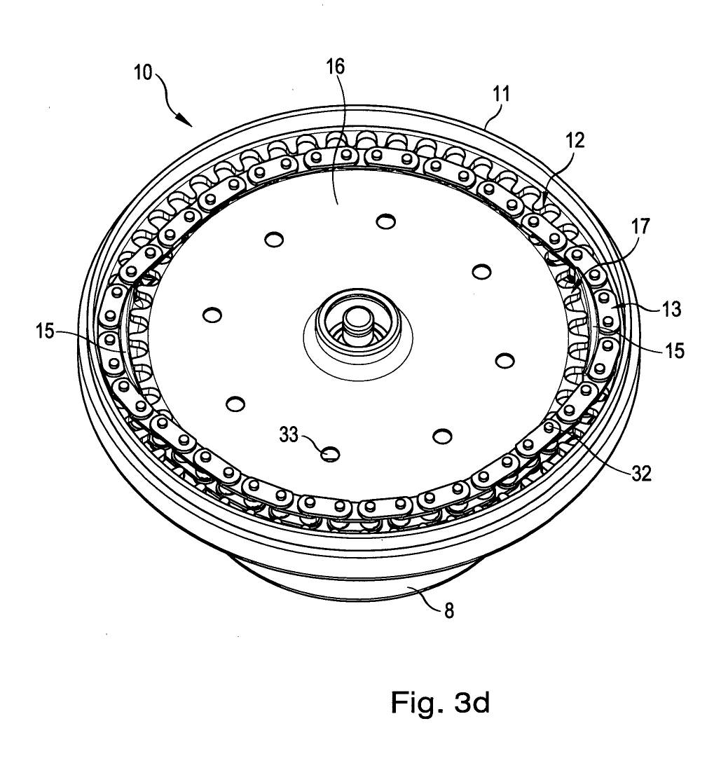

FIG. 3a a perspective view of the ring gear of the first drive stage of the transfer device from FIG. 1, comprising the motor housing of the electric motor;

FIG. 3b a perspective view of the sun gear and the activation element of the first drive stage of the transfer device from FIG. 1;

FIG. 3c a perspective assembly drawing of the ring gear, the sun gear and the activation element of the first drive stage of the transfer device from FIG. 1;

FIG. 3d a perspective assembly drawing of the first drive stage of the transfer device from FIG. 1;

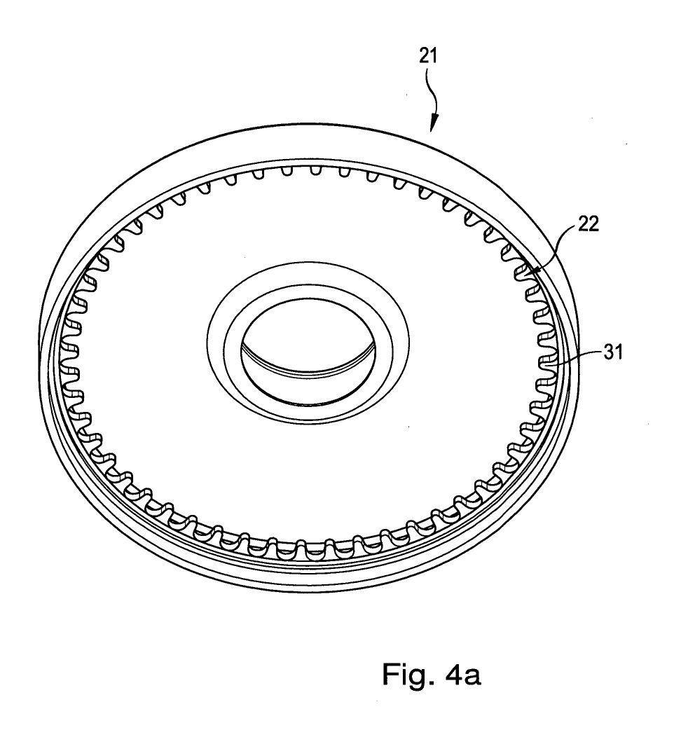

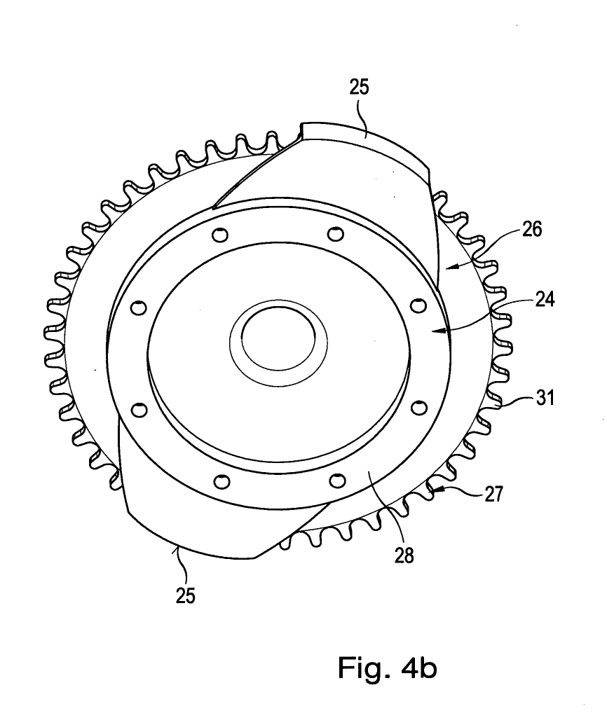

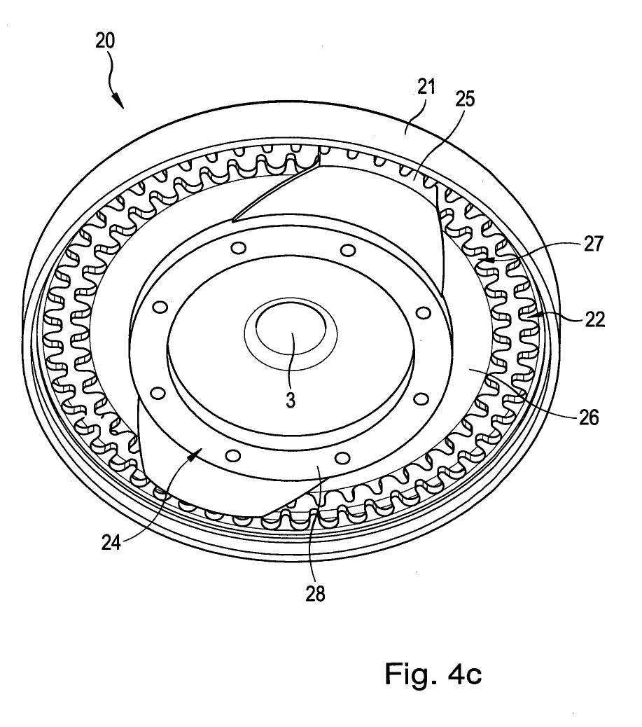

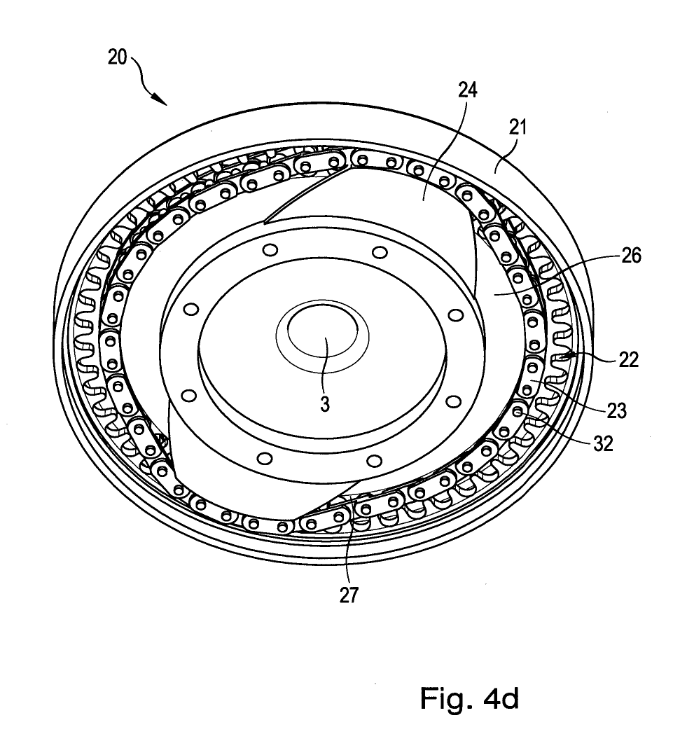

FIG. 4a a perspective view of the ring gear of the second drive stage of the transfer device from FIG. 1;

FIG. 4b a perspective view of the sun gear and activation element of the second drive stage of the transfer device from FIG. 1;

FIG. 4c a perspective assembly drawing of the ring gear, the sun gear and the activation element of the second drive stage of the transfer device from FIG. 1;

FIG. 4d a perspective assembly drawing of the second drive stage of the transfer device from FIG. 1;

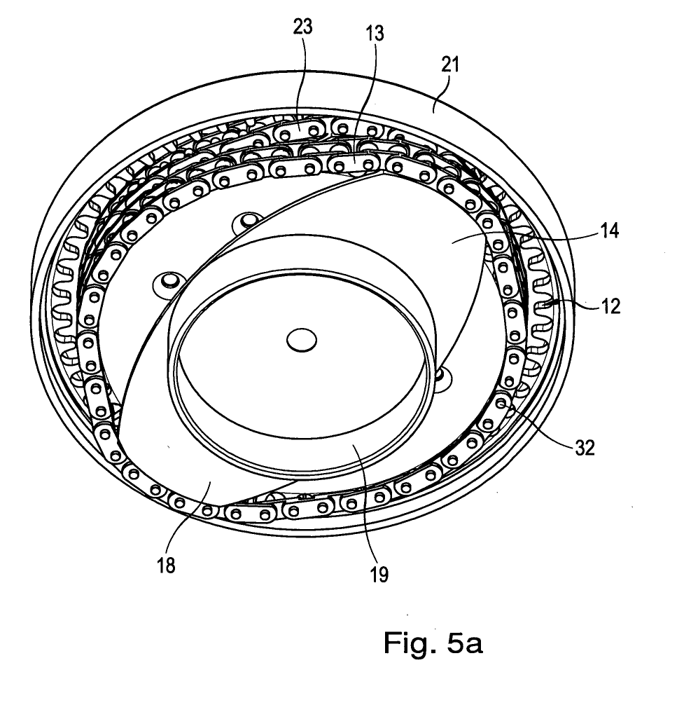

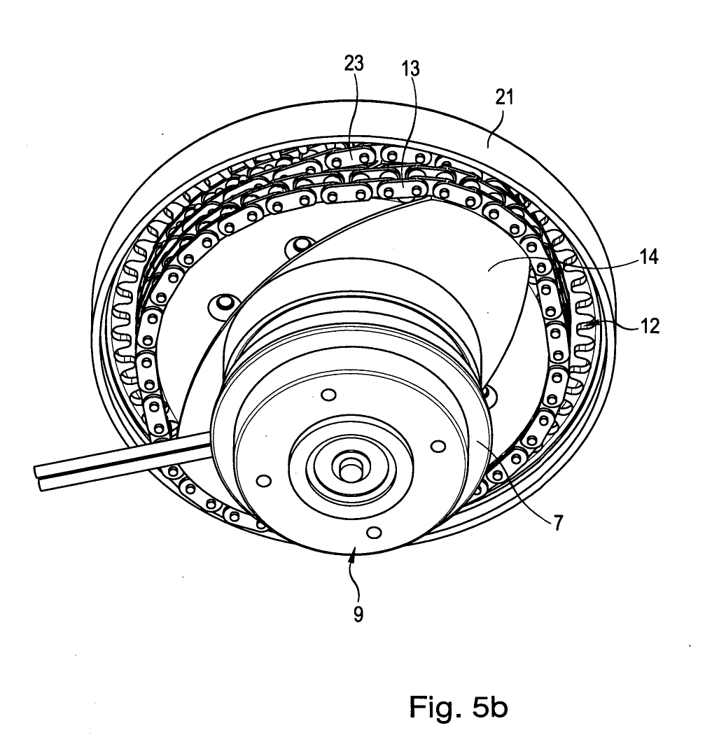

FIG. 5a a perspective partial view of the transfer device from FIG. 1;

FIG. 5b a perspective partial view of the transfer device from FIG. 1 comprising the rotor of the electric motor;

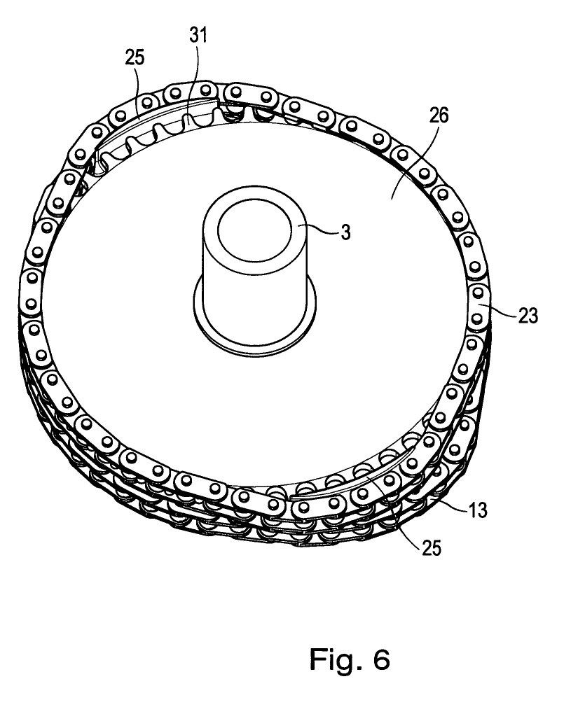

FIG. 6 a perspective view of the coupling of the activation element of the second drive stage with the sun gear of the second drive stage of the transfer device from FIG. 1;

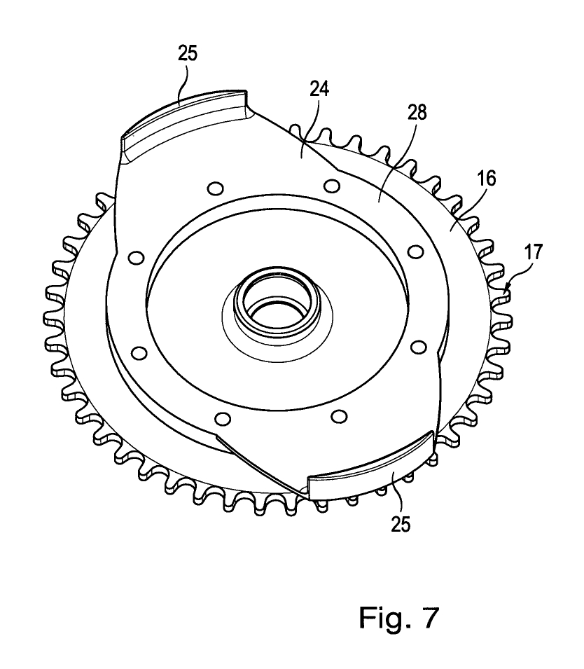

FIG. 7 a perspective view of the sun gears, the activation elements and the chains of the first and second drive stages of the transfer device from FIG. 1;

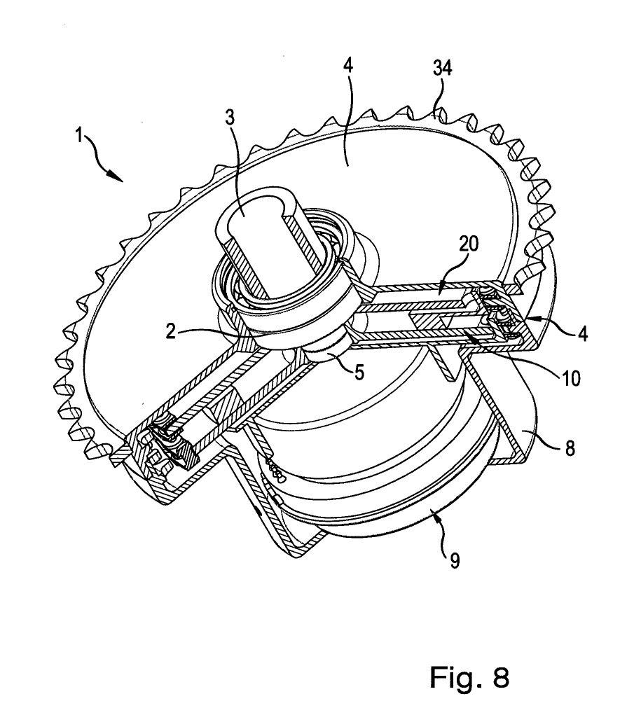

FIG. 8 a perspective view of a camphaser according to the present invention having a transfer device with variable rotation angle and a camshaft sprocket;

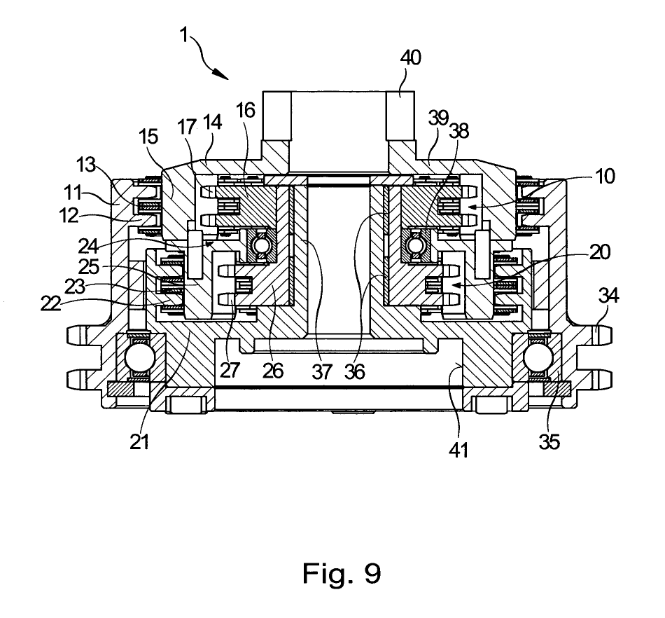

FIG. 9 a cross sectional view through a further embodiment of a transfer device with variable rotation angle according to the present invention.

FIG. 1 shows an embodiment of a transfer device 1 with a variable rotation angle according to the present invention, which can be used as a camphaser in a combustion engine. The perspective view of this transfer device 1 arranged as a two-stage drive shows a common ring gear 4 of the first and second drive stage 10, 20, a housing 8 of an electric motor 9 and in addition a camshaft 3 supported by a ball bearing 2.

The cross-section through the variable rotation angle transfer device 1 in FIG. 2 clearly shows the two-stage reduction gearing with the first drive stage 10, which is coupled with the electric motor 9 and the second drive stage 20, which is coupled with the camshaft 3. As already shown in FIG. 1, the common ring gear 4 of the transfer device 1 is configured as a two part component, this being a first ring gear 11 of the first drive stage 10 and a second ring gear 21 of the second drive stage 20, which in this embodiment are permanently attached to each other. Depending on the needs of the gearing and the self-locking property of the transfer device 1, the first ring gear 11 and the second ring gear 21 can also be configured as being movable relative to one another. The first ring gear 11 of the common ring gear 4 exhibits a first interior toothing 12, which engages with the first chain 13 of the first drive stage 10. In this case, the first chain 13 is held in place by the chain guide rails 15 of the first circumferential chain scraper 14 of the first drive stage 10 as it engages with the teeth of the interior toothing 12 of the first ring gear 11. The first chain 13 engages into the externally toothed first sun gear 16 of the first drive stage 10 in an area of the first drive stage 10 not shown in FIG. 2. The first externally toothed sun gear 16 is supported by a bearing and rotates on the exterior ring of the motor bearing 5. The first circumferential chain scraper 14 engages the rotor 7 (not shown in detail) of the electric motor 9 on the side facing away from the first sun gear 16. In this case, the first circumferential chain scraper 14 also forms a protrusion 6 engaged into the motor bearing 5, which is a bearing support for rotor 7, on the side facing the first drive stage 10. As can be easily seen in the cross section of FIG. 2, the motor housing 8 is fixedly coupled to the first ring gear 11, so that motor 9 rotates with the first ring gear 11 of the first drive stage 10. In order to couple the first drive stage 10 with the second drive stage 20, the first sun gear 16 of the first drive stage 10 is connected with the second circumferential chain scraper 24 of the second drive stage 20. The second chain 23 is pushed onto the interior toothing 22 of the second ring gear 21 by means of the chain guide rails 25 of the second circumferential chain scraper 24. The second chain 23 of the second drive stage 20 engages into the exterior toothing 27 of the second sun gear 26 in an area not shown in the cross section drawing in FIG. 2. The second sun gear 26 is connected with camshaft 3, which is then borne by the roller bearing 2 of the camshaft 3. The second internally toothed ring gear 21 extends from the interior toothing 22 in parallel to the second sun gear 26 to the exterior ring of the roller bearing 2, so that the second ring gear 21 and the second sun gear 26 can be rotated relative to one another.

FIG. 3a shows a perspective view of the first internally toothed ring gear 11 of the first drive stage 10. This clearly shows the individual teeth 31 of the interior toothing 12. Since the teeth 31 of the interior toothing 12 merely engage into the chain links 32 of the first chain 13, the interior toothing 12 can be manufactured with simple means, for instance by milling or stamping. In contrast to a conventional planetary gear, such an interior toothing 12 or the exterior tooth 17 of the first sun gear 16 does not need to be configured as a precision ground gear. The new transfer device 1 merely requires employing the simple manufacturing processes known for chain sprockets from the high-performance drive chain field. In this case, the motor housing of the electric motor 9 is permanently fixed to the first ring gear 11, so that the motor housing 8 jointly rotates with the first ring gear 11 when the transfer device 1 is operated. Instead of an electric motor 9 with a rotating stator, the system can also use motors with a stator fixed to the housing, which then requires a corresponding bearing between the motor housing 8 and the first ring gear 11.

Correspondingly, the first sun gear 16 of the first drive stage 10 with the exterior toothing 17, as shown in the perspective view in FIG. 3b, can also be manufactured by simple means. In addition to the first sun gear 16, this also shows the first circumferential chain scraper 14, wherein the two chain guide rails 15 extend in the direction of the exterior toothing 17 of the first sun gear 16, and cover this in a relatively tight manner. The exterior toothing 17 of the first sun gear 16 has 46 teeth. The chain guide rails 15 of the first circumferential chain scraper 14 are on the side facing the first sun gear 16 with a narrow space in close proximity to the teeth 31 of the exterior toothing 17. In contrast to this, the radius of the chain guide rail 15 changes along the outside of the chain guide rails 15 and the chain guide rails 25 of the second circumferential chain scraper 24 in such a way that the two ends are configured relatively thin, and the centre of the chain guide rail 15 is relatively thick. This permits the first chain 13, as well as the second chain 23, to be easily disengaged or lifted from the first sun gear 16, and to be pushed onto the interior toothing 12 of the first ring gear 11. The center of the first sun gear 16 clearly shows the protrusion 6 of the first circumferential chain scraper 15, which is supported by the motor bearing 5.

The perspective assembly drawing of the first drive stage 10 in FIG. 3c shows a circumferential gap between the interior toothing 12 of the first ring gear 11 and the exterior toothing 17 of the first sun gear 16, which enables free rotation of the chain guide rails 15 of the circumferential chain scraper 14 between the first ring gear 11 and the first sun gear 15. Correspondingly, the interior toothing 12 of the first ring gear 11 with 52 teeth comprises a higher tooth count than the exterior toothing 17 of the first sun gear 16 with 46 teeth. In addition to the first ring gear 11, which is connected to the motor housing 8, this drawing again shows the protrusion 6 on the first circumferential chain scraper 14 located on the reverse side of the first sun gear 16, and a series of holes 33 in the first sun gear 16, which are equidistant to the center of the first sun gear 16.

FIG. 3d shows a perspective view of the first drive stage 5, wherein the first chain 13 is also inserted between the first ring gear 11 and the first sun gear 16. In this case, the chain 13 is pushed onto the interior toothing 12 of the first ring gear 11 by the chain guide rails 15 and the first circumferential chain scraper 14, and is correspondingly prevented from engaging with the exterior toothing 17 of the first sun gear 16. Because the enclosed chain 13, which wraps around the sun gear 16, has a differing number of interior spaces between the chain links 32 of the double sided link chain 13, which contrasts to the tooth count of the interior toothing 12 and exterior toothing 17, the chain 13 is pulled back onto the exterior toothing 17 of the first sun gear 16 after the chain guide rails 15, and travels in close contact along sun gear 16 until it reaches the next chain guide rail 15. This correspondingly permits a relative movement between the first ring gear 11 to the first sun gear 16, during rotation around the first sun gear 16, when the first circumferential chain scraper 14 disengages the first chain 13 from the exterior toothing 17 of the first sun gear 16 and partially pushes it onto the interior toothing 12 of the first ring gear 11.

FIG. 4a shows a perspective view the reverse side of the interior toothed second ring gear 21 of the second drive stage 20. The interior toothing 22 of the second ring gear 21 again clearly shows the individual teeth 31, which are formed for a reliable and low-friction engagement with the chain links 32 of the second chain 23. Corresponding to the first drive stage 10, the interior toothing 22 of the second ring gear 21 also has 52 teeth.

The second sun gear 26 and the second circumferential chain scraper 24 of the second drive stage 20 are shown in the bottom perspective in FIG. 4b. In this case, the chain guide rails 25 are affixed on two opposing sides of the second circumferential chain scraper 24, respectively on protrusions extending from the centered mounting ring 28 toward the outside.

FIG. 4c shows a bottom perspective view of the assembly of the second drive stage 20 with the second sun gear 26, second circumferential chain scraper 24 and second ring gear 21, but without the second chain 23. Moreover, FIG. 4c shows that the second ring gear 21, the second sun gear 26 and the second circumferential chain scraper 24 of the second drive stage 20 are arranged coaxially to the shaft axis of the camshaft 3, in order to rotate with, or around the camshaft 3.

The complete second drive stage 20 is shown in the bottom perspective view of FIG. 4d. The second chain 23 is lifted from the exterior toothing 27 of the second sun gear 26 by the chain guide rails 25 during movement of the second circumferential chain scraper 24, and pushed onto the interior toothing 22 of the second ring gear 21. In the second drive stage 20 as well, the second chain 23 also has 48 interior spaces between the chain links 32 of the closed, rotating second chain 23 to engage the teeth 31 of the exterior toothing 27 of the second sun gear 26 or the teeth 31 of the interior toothing 22 of the second ring gear 21.

The variable rotation angle transfer device 1 according to the invention is shown in FIG. 5a in an open bottom perspective view, wherein the electric motor 9 and the first ring gear 11 were omitted for ease of understanding. This shows the oval shape of the base plate 18 of the first circumferential chain scraper 14, the ends of which protrude past the first sun gear 16 and are configured with the chain guide rails 15, and has a ring-shaped receiver 19 for receiving or coupling a rotor 7 of the electric motor 9. During the rotation of the first circumferential chain scraper 14 around the axis of the camshaft 3, which protrudes through the protrusion 6, the first chain 13 is lifted from the exterior toothing 17 of the first sun gear 16 and pressed into the interior toothing 12 of the first ring gear 11, which is not shown here, so that the first sun gear 16 and the first ring gear 11 move relative to the first circumferential chain scraper 14, while subject to reduction gearing. The first sun gear 16 then transfers the movement to the second circumferential chain scraper 24 of the second drive stage 20.

The perspective bottom view in FIG. 5b once again shows the first and second drive stage 10, 20 of the transfer device 1, wherein the rotor 7 of the electric motor 9 is positioned in the receiver 19 of the first circumferential chain scraper 14.

Furthermore, FIG. 6 shows a perspective top view of the first drive stage 10 and the second drive stage 20 of the transfer device 1, wherein the first ring gear 11 and the second ring gear 21 are no longer shown. This top view onto the second sun gear 26 of the second drive stage 20 clearly shows its connection to the camshaft 3. The second chain 23 is lifted from the exterior toothing 27 of the second sun gear 26 by the chain guide rails 25 of the second circumferential chain scraper 24, wherein the lifting action of the second chain 23 by the chain guide rails 25 tensions the second chain 23 in the remaining regions of the second sun gear 26 along the exterior toothing 27.

The perspective top view of FIG. 7 shows the connection between the second circumferential chain scraper 24 and the first sun gear 16. The holes 33 configured in the first sun gear 16 are used to connect the base ring 28 of the second circumferential chain scraper 24 by means of screws or other suitable fastening means to the first sun gear 16.

The partially cut away perspective view of the transfer device 1 with a variable rotation angle in FIG. 8 shows the embodiment of a camphaser with a camshaft chain sprocket 34 arranged on the outside diameter of the common ring gear 4, here on the second ring gear 21 of the second drive stage 20. The camshaft chain sprocket 34 is prevented from rotating by a connection of a suitable timing chain (not shown) to the crankshaft (not shown) of the combustion engine. In this case, the camshaft chain sprocket 34 is connected during operation to the camshaft 3 via the drive stages 10, 20, so that the movement of the camshaft chain sprocket 34 can be directly transferred to the camshaft 3. As is also shown in FIG. 2, the cross-section through the transfer device 1 in FIG. 8 also shows the components of the first and second drive stage 10,20, as well as the electric motor 9.

The cross-sectional view through a further embodiment of the transfer device 1 with variable rotation angle, shown in FIG. 9, also depicts a two-stage reduction gearing. However, this transfer device 1 is designed as a subtracting gear having a first drive stage 10, which is coupled by a ring-shaped socket 40 with the electric motor 9 (not shown), and a second drive stage 20, which is coupled with the camshaft 3 (not shown). This transfer device 1 having a first ring gear 11 of the first drive stage 10 and a second ring gear 21 of the second drive stage 20, which are movable relative to one another, wherein the first ring gear 11 is supported on the second ring gear 21 by a ball bearing 35. The second ring gear 21 is provided with a ring-shaped receiver 41 for attaching an end of the camshaft 3. The ring-shaped receiver 41 is further designed to create a seat for the ball bearing 35. Additionally, the second ring gear 21 having a plug 37 extending on the opposite side of the ring-shaped receiver 41 from the second ring gear 21 towards the ring-shaped socket 40 receiving the electric motor 9. First ring gear 11 of the first drive stage 10 is provided with a camshaft sprocket 34 arranged on the outside diameter of first ring gear 11, wherein the camshaft sprocket 34 is positioned above the ball bearing 35 in order to avoid imbalance of the transfer device 1.

The electric motor 9 is coupled to the first circumferential chain scraper 14 by the ring-shaped socket 40 receiving or coupling a rotor 7 of the electric motor 9. The ring-shaped socket 40 is connected to the first circumferential chain scraper 14 by an internally extending flange 39 of the first chain scraper 14. In this embodiment, the electric motor 9 is connected to the first circumferential chain scraper 14 pushing a first link chain 13 of the first drive stage 10 onto the first interior toothing 12 of the first ring gear 11. Thus, the first ring gear 11, which is engaged by the first link chain 13, is held in place with regard to the chain guide rails 15 of the first circumferential chain scraper 14 and the first sun gear 16 as long as the motor 9 does not actuate the first circumferential chain scraper 14. Apart from the chain guide rails 15 of the first circumferential chain scraper 14, the first chain 13 engages into the externally toothed first sun gear 16 of the first drive stage 10, wherein these areas of a first drive stage 10 are not shown in FIG. 9.

The first and second sun gears 16, 26 are supported by bush bearings 36 mounted on the plug 37 extending from the ring-shaped receiver 41 of the first ring gear 11 towards the ring-shaped socket 40 and the motor 9. The second sun gear 26 having an extension towards the ring-shaped socket 40 for receiving the first sun gear 16 of the first drive stage 10, wherein the first sun gear 16 is fixedly coupled to the second sun gear 26. Between the first sun gear 16 and the second sun gear 26, a further ball bearing 38 is provided, wherein the interior ring of the ball bearing 38 is seated on the extension of the second sun gear 26. The exterior ring of the ball bearing 38 is designed to provide a bearing for the second chain scraper 24 of the second drive stage 20 and the first chain scraper 14 of the first drive stage 10. As shown in FIG. 9, the first circumferential chain scraper 14 and the second circumferential chain scraper 24 may be permanently attached to each other. Depending on the needs of the gearing and the self-locking properties of the transfer device 1, the first chain scraper 14 and the chain scraper 24 may also be configured as being movable relative to one another.

Between the second sun gear 26 and the second ring gear 21 of the second drive stage 20, the second chain 23 is arranged, wherein the chain 23 is lifted by the chain guide rail 25 of the second circumferential chain scraper 24 of the second drive stage from the exterior toothing 27 of the second sun gear 26 and pushed onto the interior toothing 22 of the second ring gear 21.

The camshaft sprocket 34 is connected to a crankshaft (not shown) of the combustion engine by a suitable timing chain (not shown). The camshaft sprocket 34 is connected during operation to the camshaft 3 via the interior toothing 12 of the first ring gear 11 meshing with the first chain 13, which is held in position by the chain guide rails 15 of the first circumferential chain scraper 14 and transfers the movement of the camshaft sprocket 34 to the first sun gear 16. The first sun gear 16 is fixedly coupled to the second sun gear 26, which delivers the movement via the second chain 23, which is held in place on the second sun gear 26 by the second circumferential chain scraper 24 fixedly coupled to the first chain scraper 14, to the second ring gear 21, which is connected to the camshaft 3 at the ring-shaped receiver 41.

Electric motor 9, which is coupled to the first circumferential chain scraper 14 by the ring-shaped socket 40 and the internally extending flange 39, drives the first chain scraper 14 of the first drive stage 10. Due to the rotation of the first circumferential chain scraper 14, the first double-sided link chain 13, engaging the interior toothing 12 of the first ring gear 11 and exterior toothing 17 of the first sun gear 16, moves the the first sun gear 16 relative to the first ring gear 11. The first chain 13 is pushed by the chain guide rails 15 of the first chain scraper 14 onto the interior toothing 12 of the first ring gear 11 and is partly tensioned over the exterior toothing 17 of the first sun gear 16. With the first sun gear 16 of the first drive stage 10, also the second sun gear 26 of the second drive stage 20 is moved at the same rotational speed due to the fixed coupling between the first and the second sun gears 16, 26. Due to the movement of the second gun gear 26, the second double-sided link chain 23 of the second drive stage 20, which is engaged by the teeth 31 of the exterior toothing 27 of the second sun gear 26, is moved along the chain guide rails 25 of the second circumferential chain scraper 24, lifting the second chain 23 from the exterior toothing 27 of the second sun gear 26 and pushing the second chain 23 into engagement with the interior toothing 22 of the second ring gear 21. Due to the movement of the second chain 23, the position of the second ring gear 21, relative to the first ring gear 11, is moved. Thus, the activation of the first chain scraper 14 by the electric motor 9 changes the rotation angle between the camshaft sprocket 34, which is fixedly coupled to the first ring gear 11, and the camshaft 5, which is fixedly connected to the second ring gear 21.

Contrary to the embodiment of the transfer device 1 shown in detail in FIGS. 1 to 7, at the subtracting gear device in FIG. 9 the gear ratio of the first drive stage 10 and the second drive stage 20 differs from one another. For the first drive stage 10, the diameter and the number of teeth and chain links 32 respectively of the first sun gear 16, the first link chain 13 and first ring gear 11 clearly differ from the tooth count and chain link count respectively of the second sun gear 26, second link chain 26 and the second ring gear 21 of the second drive stage.

The following explains the function and operating principle of a transfer device 1 with a variable rotation angle according to the invention in greater detail. The general construction of a transfer device 1 according to the present invention having first and second drive stages 10, 20 with first and second sun gears 16, 26, first and second link chains 13, 23, first and second chain scraper 14, 24 and first and second ring gears 11, 21, provide a large variety of connection designs as well as a large variety of different gear ratios for the whole transfer device 1 as well as for the first and second drive stages 10, 20. A fixed connection of different components of the first and second drive stages 10, 20 as well as the selection of different components for drive input, adjusting input and drive output provide special solutions for each use of the transfer device 1. The use of one or more chain scrapers 14, 24 in an ecliptic gear drive allows the design of adding or subtracting circuits having high gear ratios.

The transfer device 1 shown in FIG. 8 is an adding gear device having fixedly connected first and second ring gears 11, 21 and a first sun gear 16 of the first drive stage 10 which is fixedly connected to the second chain scraper 24 of the second drive stage in order to transfer movement of the electric motor 9 coupled to the first chain scraper 14 of the first drive stage 10 to the second drive stage 20. The drive input is connected to the common ring gear 4, i.e. first or second ring gears 11, 21, and is transferred in the second drive stage 20 from the second ring gear 21 via the second chain scraper 24 to the second sun gear 26, which is connected to the output of the transfer device 1, i.e. the camshaft 3, wherein the drive input is transferred to the output with no gear ratio, when the second chain scraper 24 is static. A second design for an adding gear device provides a fixed connection between the first and second sun gears 16, 26 while the first ring gear 11 is connected to the second chain scraper 24 of the second drive stage 20. The adjustment input of this transfer device 1 with variable rotation angle is connected to the first circumferential chain scraper 14 of the first drive stage 10, while the drive input is connected to the first ring gear 11. The drive output of the transfer device 1 is coupled to the second sun gear 26, so that the drive input is subject to a reduced gear ratio.

During the operation of the transfer device 1, according to the embodiment of FIG. 8, in particular as a camphaser, the movement e.g. of the camshaft sprocket 34 is transferred to the common ring gear 4 or the second ring gear 21 is transferred by the interior toothing 22 to the second chain 23 and from there via the exterior toothing 27 to the second sun gear 26. Because the second sun gear 26 is directly coupled with the camshaft 3, the camshaft 3 rotates at the same rotational velocity as the second ring gear 21. As can be well seen in FIG. 4d, the chain guide rail 25 of the second circumferential chain scraper 24 pushes the second chain 23 onto the interior toothing 22 of the second ring gear 21 and concurrently tensions the second chain 23 across the exterior toothing 27 of the second sun gear 26. As long as the circumferential chain scraper 24 remains in its relative position to the second sun gear 26 and the second ring gear 21, the movement exerted on the second ring gear 21 is directly, and without gearing, transferred onto a central shaft, such as a camshaft 3. The components of the second drive stage 20 exhibit the corresponding movement around the central shaft at the same rotational velocity. Because the circumferential chain scraper 24 of the second drive stage 20 is permanently connected with the first sun gear 16 of the first drive stage 10 (as shown in FIG. 7), all components of the first drive stage 10, the first sun gear 16, the first circumferential chain scraper 14, the first chain 13, the first ring gear 11, rotate in the same manner in unison with the second ring gear 21 of the second drive stage 20. In this embodiment having a common ring gear 4, the movement of the camshaft chain sprocket 34 is concurrently transferred via the connection between the second ring gear 21 and the first ring gear 11. In the case of a configuration of the electric motor 9 with a jointly rotating stator and an over-rotating rotor 7, the stator, and/or the motor housing 8, and the rotor 7 rotate in unison with the second drive stage 20 at the same rotational velocity as the second ring gear 21.

In case of an adjustment of the rotation angle between the first ring gear 11 and the first sun gear 16 of the first drive stage 10, which corresponds to a rotation angle adjustment between the camshaft 3 and the camshaft chain sprocket 34, which is locked with the crankshaft, the rotor 7 of the electric motor 9, which rotates in unison, is accelerated or decelerated, thus changing the position of the first circumferential chain scraper 14 to the first sun gear 16 and the first ring gear 11. The movement of the circumferential chain scraper 14 of the first drive stage 10 moves the two chain guide rails 15 along the first sun gear 16, which lifts the first chain 13 from the sun gear 16 and pushes it onto the interior toothing 12 of the first ring gear 11.

Because the tooth count differs between the interior toothing 12 of the ring gear 11 and the exterior toothing 17 of the first sun gear 16, the movement of the first circumferential chain scraper 14 causes a relative movement of the components of the first drive stage 10 to each other, which is independent from the count of the chain links 32 and the interior spaces between the chain links 32. In the depicted embodiment the exterior toothing 17 of the first sun gear 16 has a tooth count of 46 teeth, the interior toothing 12 of the first ring gear 11 has a tooth count of 52 teeth, and, whereas, the enclosed first chain 13 has a deviating count of 48 chain links and interior spaces in order to ensure a secure engagement into the first ring gear 11 and the first sun gear 16. In regard to the actuated first chain scraper 14, the ratio of the tooth count of the first sun gear 16 to the difference of the tooth count of the first ring gear 11 and the teeth of the first sun gear 16 results in a reduction gear ratio of approximately 8:1, or, as a formula 46/(52−46).

During the movement of the first sun gear 16 of the first drive stage 10, the connection of first sun gear 16 with the second circumferential chain scraper 24 (shown in FIG. 7) moves the second circumferential chain scraper 24 corresponding to the reduction gear ratio of the first drive stage 10, therefore also changing the position of the second ring gear 21 and the second sun gear 26 to each other. As the first ring gear 11 and the second ring gear 21 are fixedly coupled, the movement of the components of the second drive stage 20 is performed analogous to the movement of the components of the first drive stage 10 and is therefore not explained in further detail. In this case, the second drive stage 20 also has 52 teeth on the second ring gear 21, and the second sun gear 26 also has 46 teeth, thus again creating a corresponding reduction gear ratio. The coupling of the first and second drive stages 10, 20 of the transfer device 1 correspondingly results in an overall reduction gear ratio of approximately 60:1, or (46/(52−46))² and therefore enabling accurate rotation angle adjustments with only limited power consumption of the electric motor 9. In addition, the high reduction gear ratio also improves the self-locking feature of the variable rotation angle transfer device 1.

Transfer device 1 with a variable rotation angle according to the present invention designed as subtracting gear device provides special designs for ecliptic gears with high gear ratios and high RPM outputs. The transfer device 1 according to the embodiment of FIG. 9 provides a fixed coupling between the first and second sun gears 16, 26, while the adjustment input is connected to the first chain scraper 14 of the first drive stage 10 and the drive input is connected to the first ring gear 11 of the first drive stage 10. In this subtracting gear device, the drive output is connected to the second ring gear 21 of the second drive stage 20, allowing a high gear ratio between the drive input and the drive output.

Further subtracting gear devices, which may be useful for certain applications, such as retrofitting of present timing drives, may have a fixed coupling between first and second ring gears 11, 21 as well as a coupling between first and second chain scrapers 14, 24 wherein the adjustment input is coupled to the chain scrapers 14, 24 while the drive input is connected to the first sun gear 16 of the first drive stage. The drive output of this design is connected to the second sun gear 26 of the second drive stage 20, which allows a high gear ratio between the drive input and the drive output.

1. Transfer device (1) with variable rotation angle, specifically a camphaser for a combustion engine, with an internally toothed ring gear (11), an externally toothed sun gear (16), a transmitter element and an adjustable actuation mechanism,
characterized in that the transmitter element comprises a circumferential engagement device arranged between the ring gear (11) and the sun gear (16), and the actuation mechanism comprises an activation element that can be moved for rotation angle adjustment along the circumferential engagement device, wherein the circumferential engagement device partially engages with the interior toothing (12) of the ring gear (11) and partially engages with the exterior toothing (17) of the sun gear (16) by means of the activation element.

2. Transfer device (1) in accordance with claim 1,
characterized in that the circumferential engagement device is configured as a chain (13).

3. Transfer device (1) in accordance with claim 1,
characterized in that the activation element is configured as a circumferential chain scraper (14) with at least one chain guide rail (15) located between the internally toothed ring gear (11) and the externally toothed sun gear (16).

4. Transfer device (1) in accordance with claim 3,
characterized in that the circumferential chain scraper (14) is coaxially aligned with the internally toothed ring gear (11) and the externally toothed sun gear (16).

5. Transfer device (1) in accordance with claim 3,
characterized in that the circumferential chain scraper (14) is equipped with two opposing chain guide rails (15).

6. Transfer device (1) in accordance with claim 2,
characterized in that the chain (13) is a double sided silent link chain, wherein the individual chain links (32) of the link chain are equipped with a chain pin and a joint sleeve that encloses the chain pin.

7. Transfer device (1) in accordance with claim 1,
characterized in that the tooth count of the interior toothing (12) of the ring gear (11) is greater than the number of chain links (32) of the chain (13) and the number of chain links (32) of the chain (13) is greater than the tooth count of the exterior toothing (17) of the sun gear (16).

8. Transfer device (1) in accordance with claim 1,
characterized in that the actuation device comprises an electric motor (9) to move the activation element.

9. Transfer device (1) in accordance with claim 8,
characterized in that the electric motor (9) comprises a housing mounted stator and a rotor (7), wherein the rotor (7) is connected to the activation element.

10. Transfer device (1) in accordance with claim 8,
characterized in that the electric motor (9) comprises a jointly rotating stator and an over-rotating rotor (7) that is attached to the activation element.

11. Transfer device (1) in accordance with claim 1,
characterized in that the transfer device (1) is configured with two stages, wherein the externally toothed sun gear (16) of the first stage (10) is permanently connected to the second activation element of the second stage (20), and the second stage (20) comprises a second externally toothed sun gear (26), a second internally toothed ring gear (21), and a second circumferential engagement device, which is partially engaged with the interior toothing (22) of the second ring gear (21) and partially engaged with the exterior toothing (27) of the second sun gear (26) by means of the second activation element.

12. Camphaser for a combustion engine with a variable rotation angle transfer device (1) in accordance with one of the claims 1 to 11, wherein the internally toothed ring gear (11) is coupled to a camshaft sprocket (34) that is coupled with the crankshaft, and wherein the externally toothed sun gear (16) is coupled to a camshaft (3).

13. Camphaser for a combustion engine with a variable rotation angle transfer device (1) in accordance with one of the claims 1 to 10, wherein the transfer device (1) is configured with two stages, the second stage (20) comprises a second externally toothed sun gear (26), a second internally toothed ring gear (21), a second circumferential engagement device and a second activation element, wherein the internally toothed ring gear (11) of the first stage (10) is permanently connected to the second internally toothed ring gear (21) of the second stage (20) and the activation element of the first stage (10) is permanently connected to the second activation element of the second stage (20), and wherein the externally toothed sun gear (16) of the first stage (10) is coupled to a camshaft sprocket (34), that is coupled with the crankshaft, and the second externally toothed sun gear (26) is coupled to a camshaft (3).

14. Method for adjusting the relative rotation angle position of the camshaft (3) of a combustion engine to a camshaft sprocket (34), that is coupled with the crankshaft by means of the variable rotation angle transfer device (1) having an internally toothed ring gear (11), an externally toothed sun gear (16), a chain (13) positioned between the ring gear (11) and the sun gear (16) and an activation element, with the steps of:
moving of the activation element along the chain (13) relative to the internally toothed ring gear (11) and the externally toothed sun gear (16);
stripping the chain (13) of the external toothing (17) of the sun gear (16) and pushing the chain (13) onto the internal toothing (12) of the ring gear (11); and
adjusting of the rotation angle of the camshaft (3) coupled with the externally toothed sun gear (16) relative to the camshaft sprocket (34) coupled to the internally toothed ring gear (11).
